(19) United States
(12) Patent Application Publication
(10) Pub. No.: US 2003/0115454 A1
(43) Pub. Date: Jun. 19, 2003

(54) Identification of a data entity

(76) Inventors: Lauri Piikivi, Oulu (FI); Jukka Parkkinen, Oulu (FI); Samuli Tuoriniemi, Oulu (FI)

Correspondence Address: SCHEEF & STONE, L.L.P., 5956 SHERRY LANE, SUITE 1400, DALLAS, TX, 75225, US

(21) Appl. No.: 10/180,194

(22) Filed: Jun. 26, 2002

(30) Foreign Application Priority Data
Jun. 26, 2001 (GB) 0115601.7

(51) Int. Cl. H04L 9/00

(52) U.S. Cl. 713/155; 705/77

(57) ABSTRACT

The present invention relates to provision of data with a digital identification. A terminal (1) is adapted for transportation of data. The terminal is also adapted to provided the data with a digital identification. The identification is based on a unique code (9) associated with the terminal.

The present invention relates to provision of a data entity with an identification. The identification may be provided prior transportation of data from a user equipment via a communication media.

Various user equipment may be used for communication via a communication system. A communication system can be seen as a facility that provides a user thereof with a communication media for communication with one or more other entities such as another user equipment and/or another node connected to the communication system. Said node may comprise a data processing entity such as a server.

The communication may comprise communication of various types of content. For example, voice; data, multimedia (comprising video or other image data, voice or text data and so on) content and so on may be communicated via a communication system.

User equipment for the communication may comprise a fixed or mobile user terminal. An example of different possible fixed terminals is a personal computer (PC) connected to a data network. An example of possible mobile user terminals is a mobile station (e.g. a mobile telephone) and another is a portable computer provided with appropriate communication facility. Basic principles and operation of a mobile user equipment is known by the skilled person and is thus not explained in any greater detail. It is sufficient to note that e.g. a mobile station is capable of communication via a wireless interface with another station such as a base station of a mobile telecommunication network or other mobile station.

A user may generate new content. For example, a user may take a picture, shoot a video, create an audio presentation or otherwise create a new work. User may also be enabled to use his/hers user terminal equipment for transporting the generated content via a communication system. The content generation means and the communication terminal equipment may be in the form of a single apparatus. Alternatively, a content data entity may be transferred from a separate creation means to the communication terminal equipment for transportation of the content.

It might be advantageous in certain situations for the user it the content he/she created could be identified later on. A user who is the creator and the author of the content may wish that the content can be later on associated with him/her. For example, a user may wish to ensure that he/she is appropriately rewarded of use of content he/she has a copyright. The user may also wish that data originating from him/her can be identified later on e.g. for security reasons. This might be a useful feature e.g. in various applications enabling exchange of the so called electronic transaction data.

The inventor has found especially that it might be advantageous if data entities could be provided with an identifier reliably associates data with a user and/or user equipment from which the data is transported.

Embodiments of the present invention aim to address one or several of the shortcomings of the prior art arrangements and to provide a data identification arrangement that meets the above referred needs.

According to one aspect of the present invention, there is provided a method of providing a data entity with a digital identification, wherein a terminal adapted for transportation of the data entity provides the content of the data entity with a digital identification based on a unique code associated with the terminal.

According to another aspect of the present invention there is provided a user equipment adapted for transporting data, comprising data processing means for processing data to be transported such that the data is provided with a digital identification that is based on a unique code associated with the user equipment.

According to another aspect of the present invention there is provided a communication system comprising a node for monitoring communications in the system, said node being adapted to detect if data transmitted via the system is provided with a digital identification that is based on a unique code associated with a user equipment.

In more specific forms of the invention the unique code comprises an equipment identity code and/or a subscriber identity code associated with the terminal. The unique identifier may also be provided by a digital certificate. Information associated with the unique code may be stored in the terminal. The information may be stored in a subscriber identity module.

The digital identification may be provided by digitally modifying the data content. The digital modifying may be based on a shared secret. The modification may be provided by watermarking the content.

The terminal may automatically provide the digital identification before transmission of data therefrom.

Data may be transported via a communication system provided with means for detecting if the content is used or is going to be used by a user equipment.

The author of content communicated via a communication system may be identified based on the digital identification and said author may be rewarded based on detected use of the content by another party.

The embodiments of the invention may provide a substantially user friendly way for collection payments such as copyright payments of use of data content. Even substantially small payments may be collected. The embodiments may also be used for other content transmissions wherein the originator needs to be identified, such in provision of financial services or rewards associated with use of certain services (e.g. the so called bonus schemes).

For better understanding of the present invention, reference will now be made by way of example to the accompanying drawings in which:

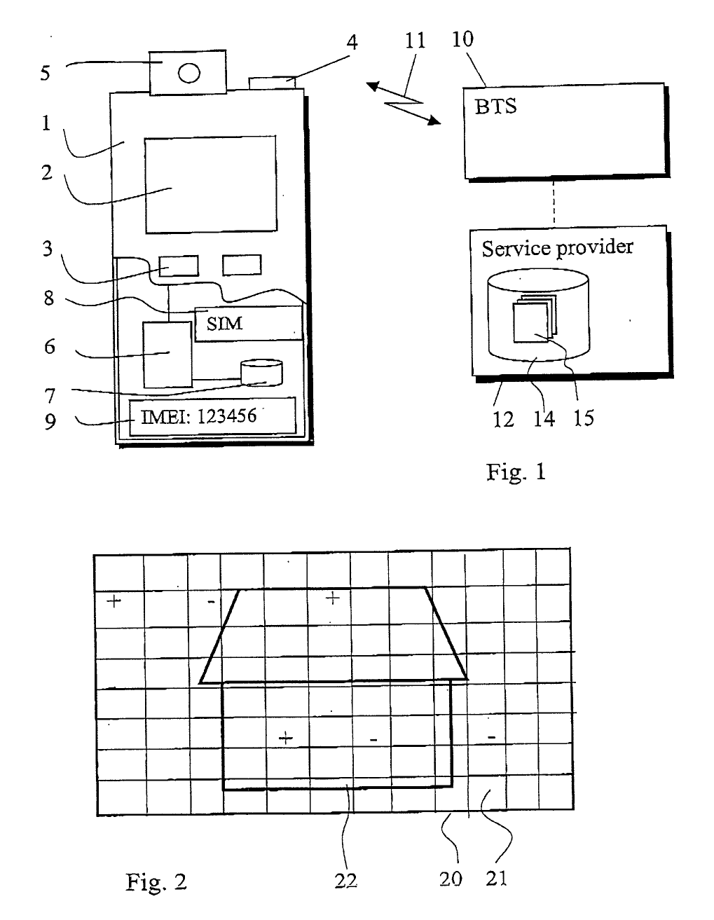

FIG. 1 shows one embodiment of the present invention;

FIG. 2 shows a possibility for provision of a digital identification;

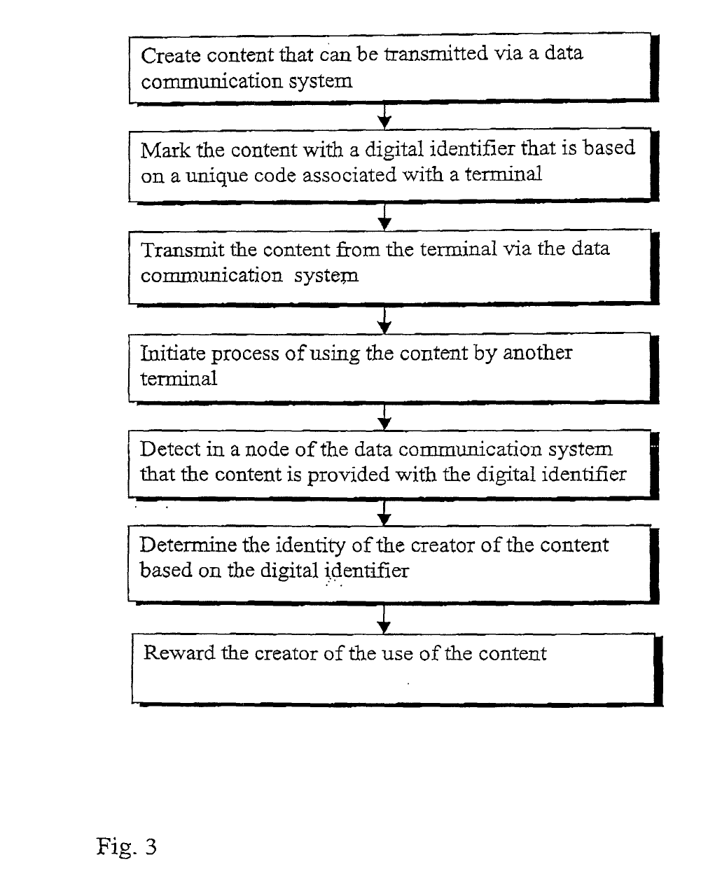

FIG. 3 is a flowchart illustrating the operation of one embodiment of the present invention; and

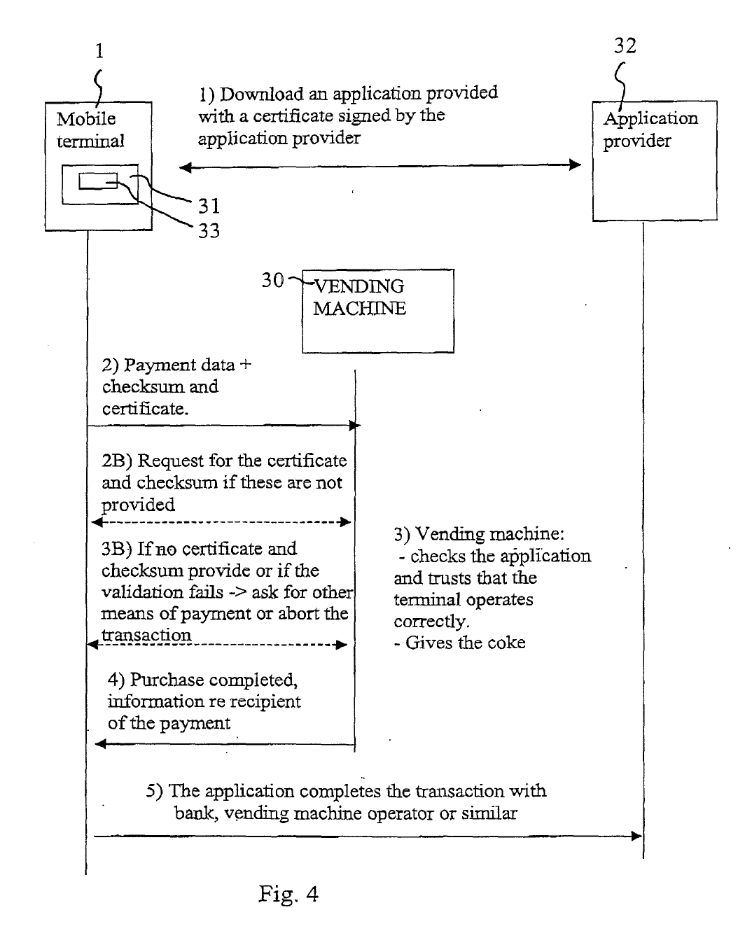

FIG. 4 illustrates of a further embodiment.

Reference is made to FIG. 1 showing an embodiment wherein a user equipment 1 may be used for transportation of digital multimedia content. It shall be appreciated that although the following will describe transportation of multimedia content such as image data or video data, the embodiments are applicable to any digital content such as voice or text content.

In FIG. 1 the user terminal is shown to comprise a mobile user equipment. More particularly, FIG. 1 shows a partially sectioned view of a mobile station 1 that may be used for communication of content over a wireless interface 11 between the mobile station 1 and a transceiver entity such as a base station 10 of the a mobile communication system. Various possible transceivers entities that may be in communication with the mobile station 1 are known and are thus not described in any greater detail. Other elements of a cellular communication system are also known by the skilled person and are omitted from FIG. 1 for clarity reasons.

The mobile station 1 may be provided with user interface means comprising a display 2 and input means. The skilled person is familiar with different user interfaces of a mobile station and therefore these will not be described in more detail herein. It is sufficient to note that the input means may be formed by control buttons 3 or they may include e.g. voice activation or touch screen means and so on. The mobile station 1 is also provided with communication interface means such as antenna means for communication with the other transceiver entity. The antenna means may comprise an external antenna element 4, or then built-in or integrated antenna means may be used. It should be appreciated that the antenna means are only shown for the reasons of completeness and do not form an essential element in view of the operation of the present invention.

The mobile station 1 is adapted to facilitate use thereof for generation and transportation of digital content. More particularly, the user of the mobile station 1 may create images by image creation means 5. The image creation means may comprise e.g. a digital camera or other image data creation means adapted to generate image data content.

The mobile station 1 is also shown to comprise a data processing entity 6 and data storage means 7. These are adapted to process and store image data provided by the image creation means 5. The processor entity 6 may also be used for controlling reception and/or transmission of data content from and/or to the other parties.

A more detailed example of provision of data with a digital signature or identification will now be explained with reference to all FIGS. 1 to 3. The identification is provided so that the content can be identified later e.g. for the purposes of copyright payments, for security reasons and so on.

As shown by FIG. 3, after content has been generated but before it is transported from the mobile station 1 the content is marked with a digital identification. The identification is then later on used for associating the content with the specific mobile station and/or the user thereof.

A technology referred to as watermarking can be used for invisibly adding information to content thus enabling identification thereof at later time. FIG. 2 illustrates the basic principles of watermarking in the context of an image data file for an image 20 of a house 22. The image 20 is shown to be divided into pixels 21. Each of the pixels is assigned with a colour code. The skilled person is familiar with the concepts of pixels and pixel colour codes, and therefore these are not explained in more detail.

The image data file is processed based on a predefined algorithm such that the colour codes of the pixels 21 of the image 20 are slightly modified in order to produce a “watermark” on the image data. The modification can be performed by processing digitally the image pixel data. As shown in the highly schematic FIG. 2, the colour codes of some of the pixels 21 have been made stronger (+) while the colour codes of some other pixels have been weakened (−) by the modification.

The watermark produced on the image data can be used to include information associated with the unique identity code in the image data 20 to be transported. Information associated with the unique identification code is then transported by means of the modified colour codes. When the image 20 is downloaded or otherwise used the identity code presented by the watermark can be interpreted based on knowledge of the algorithm used for inserting the code in the data. Since the watermarking forms a part of the image data and may itself contain redundancy the watermarking remains even in format conversions.

The mobile station 1 is preferably adapted to automatically mark any content transmitted therefrom with the watermark. The inserted watermark is adapted to carry information by means of which it is possible to identify the user of the mobile station 1 (the creator of the content) later on. The processing entity 6 can be adapted to control the marking of data content with a digital identification.

The digital modification of the data may be based on a shared secret. The secret may be shared between the creator of the content and the service provider 12. The secret may also be shared between the creator and a terminal using the content.

The inventor has found that if a user or user equipment is provided with an unique identifier the origin of data content may be reliably determined is the data is modified to carry a digital identification that is indicative of said unique identifier. Based on a unique identifier code the content can then be later on tied to the user equipment and/or the user.

A possible unique identifier can be provided based on the international mobile equipment identity (IMEI) code 9 of the mobile station 1. The IMEI code is a global unique identifier that is assigned for the mobile station 1 during the manufacture thereof.

The identification may also be based on a specific digital certificate that is stored in the mobile station. The digital certificate may be installed by the manufacturer during the manufacture of the mobile station. Such certificate may then be used to identify the terminal itself. The digital certificate may alternatively be installed at a later stage when the user is known, e.g. by the provider of identification services or the network operator. Such a certificate can then be used for identifying the user (owner) of the mobile station.

An identification of the user equipment and the user may be provided by means of a unique subscriber identity code associated with the terminal. The subscriber identity code may comprises the international mobile subscriber identity (IMSI) code. This is typically provided in a subscriber identity module (SIM) 8 of the mobile station 1. The SIM may itself be provided with a unique identification code. The SIM may also contain data associated with other unique codes such as a code provided by means of a digital certificate and so on.

Mobile stations that are constructed in accordance e.g. with the GSM (Global System for mobile communication) system or the third generation (3G) UMTS (Universal Mobile Telephone Service) are provided with an identity module and the IMEI and IMSI codes. The advantage of these codes is that they are unique. That is, only one device can be provided with an international mobile equipment identification and only one subscriber may have the same subscriber identity. Furthermore, although IMEI and/or SIM codes may be known by the operator the user subscribes to or by a plurality of operators, these codes can be considered to form a shared secret that is not in the public domain.

The content can be securely tied to the creator i.e. author thereof or to his/hers terminal equipment based on the unique and secret codes. Thus it is possible to arrange collection of e.g. copyright payments or other payment when the content is used based on the identification. An identification that is based on a secret and unique identity code associated with the user or the user equipment of the user enables effective collection of data regarding the use of the content. This enables provision of services for charging the use of any content that is made available by means of a substantially simple and “normal” user equipment. The embodiments may also enable collection of substantially small payments as the fee collection may be made automatic and transparent for the users.

FIG. 1 shows also an entity 12 that is referred to by the term ‘service provider’. The service provider shall be understood to be any entity that is adapted to identify the user equipment 1 and/or the user based on the digital identification mark provided on the data content. In a practical implementation the service provider 12 may comprise a server that is adapted for provision of an identification service for the user of the mobile station 1.

When the content is consumed or downloaded the watermark can be checked and a payment to the originator (creator) may be made before consumer is allowed to actually use the content, e.g. view an image. The identity of the creator is determined based on information of the unique code associated with the user equipment.

Creator's identity can be checked e.g. in a server that provides the content before download of the content or in the consuming mobile terminal after the download of the content. According to a possibility the communication system is provided with a special node adapted to verify if any material passing the node is marked with an identification.

The monitoring and verification of the watermarking may be accomplished e.g. by the service provider entity 12 of FIG. 1. The service provider entity 12 may comprise a database 14 including records 15 for all such users who subscribe to the service and wish to receive compensation whenever content created by them is consumed. For example, the service provider entity 12 may provide payments for any such user who has registered to the service and whose IMEI, digital certificate, IMSI and/or SIM is known to it.

The system may be employed for collecting payments associated with content downloads from network servers, for example from a music publisher service. The proposed content identification may also be used for downloads from peer mobile terminals, for example from a phone of a friend or other party in occasions wherein content is downloaded directly from another terminal. Thus identification such as the watermarking enables peer-to-peer e-business cases.

The financial settlement between the consumer of the content and the creator can be accomplished in various manners. According to a possibility the consumer (i.e. the user of the downloading terminal) may have an “open” account for the payments. The account may be prepaid or the consumer may be billed later on. The account service is informed by the monitoring service of any watermarked content that is delivered to the consumer and the balance on the account is managed accordingly. The use of the content may also be billed e.g. in the telephone bill of the consumer.

The user of the terminal 1 may he provided with possibility to selectively disable the marking feature e.g. for security or privacy reasons.

The last node at the network side before the consumer terminal may be adapted to destroy the unique code from the content. For example, a controller of the base station via which the content is transmitted to the consuming user equipment may remove the watermarking, i.e. return e.g. image data to the unmodified form thereof.

Instead of creating the content by the camera means 5 integrated with the user terminal 1 the content may be generated by another device and loaded to the terminal 1 fox transportation. Such external devices are not shown in FIG. 1, but may comprise e.g. a digital camera (still or video camera), audio recorder, image or audio editing tool, text content generation tool, a PC and so on.

In the above example the identification is provided by watermarking image data such that image pixel colour values are modified. Watermarking can be also be provided with other type of content, such as by modifying audio sample bytes of content comprising audio data. Thus it shall be appreciated that the content to be marked can consist any data, such as images, video frames, audio samples, text and so on.

It should be appreciated that whilst embodiments of the present invention have been described in relation to mobile stations, embodiments of the present invention are applicable to any other suitable type of user equipment. It shall also be appreciated that instead of using e.g. the entire IMEI or SIM code, only a part of such code can be used. For example, only first 5 digits of the IMEI or IMSI can be used. According to a possibility a portion of at least two different codes is used for the provision of the unique identification code.

The processor function for marking the content with a digital identification may be integrated with at least one other processor function of the mobile station 1. The processor function may alternatively be adapted to process only data that associates with the data content transmissions. The data storage means 7 may also be either integrated with at least one other function of the mobile station 1 or be assigned solely for storage of image data and/or other data that associates with data content transmissions. Separation of the data content transmission and/or marking functions from other functions of the mobile station 1 may be preferred e.g. for security or usability reasons.

It shall be appreciated that the digital identification may be employed in any application wherein identification of a data is required. For example, the identification may be provided for use in electronic transactions. The user may wish to pay for various goods and/or services by means of the mobile user equipment 1 or access various banking services by the mobile station 1. The mobile user equipment 1 may also be used for ordering, negotiating or purchasing goods and/or services, for receiving a receipt of a purchase, an electronic ticket or for any other operation where data needs to be exchanged between the user and another party. Examples of other possibilities include use of the mobile user equipment 1 for transactions that associate with betting, insurance, or other services requiring financial transactions. A still further example includes identification for the purposes of various bonus schemes. A user may be rewarded e.g. by bonus points if he/she takes predefined actions by means of this/hers terminal. In all these cases data can be digitally modified to include a unique identifier for identifying a user equipment and/or the user of the equipment.

A more detailed example of financial transactions will now be explained in association with substantially small payments and with reference to FIG. 4. For example, a user may wish to pay for a coke at a vending machine 30 by means of his/hers mobile user equipment 1. The user equipment 1 may be provided with an appropriate payment application 31. Various payment applications are known, and therefore these are not discussed in more detail. It is sufficient to note that the application 31 may be based on any appropriate data processing technology, such as the Java.

In FIG. 4 the user equipment downloads the application 31 at step 1) from a payment application provider 32. A successfully downloaded and installed application 31 has a certificate 33 signed and/or otherwise certified by the application provider 32. The user equipment 1 is thus provided with an application which in turn is provided with a unique digital identification. The unique identification may be formed by the certificate and a so called checksum. The checksum may be a simple calculation giving a sum that should match a predefined sum for the application. More complicated algorithms may also be used. For example, a hash algorithm may be used for the computation of the checksum. The checksum computations may employ information about the binary code of the application.

At step 2) the user pays a drink can by transmitting payment data e.g. via a wireless communication media between the user equipment 1 and the vending machine 30. The wireless communication media may comprise a local low power link. The communication media may alternatively be based on a cellular telecommunication system the user equipment subscribes to. Other type of communication media may also be used.

The identity of the application 31 may be automatically added to the transaction data whenever it is transmitted to other parties, e.g. the vending machine 30, from the user equipment 1. The recipient 30 may then accomplish required calculations to ensure that the payment operation is accomplished correctly. A checksum may be calculated at stage 3) when the vending machine 30 processes the transaction data. The checksum may be computed based on the certificate 31 issued by the payment service provider 32.

If the recipient trusts the received transaction data it allows the transaction to proceed. That is, if the checksum computation indicates that the user equipment operates correctly and can be trusted, the vending machine proceeds with the delivery of the drink can. If the checksum is not provided or the calculation fails, the transaction is aborted or other means of payment are required to be used, step 3B.

The vending machine 30 may trust the application itself to report the purchase to a bank, a vending machine operator or other payment service provider in order to transfer the payment to the vending machine operator. Alternatively the vending machine 30 may report the purchase directly to a payment service provider.

The application 31 itself can ask the vending machine to perform the calculations. The application 31 may be instructed by the vending machine during the transaction phase by, for example, an HTTP-protocol message field requesting data for calculation of the checksum to add data associated with the checksum calculation from the user equipment 1, see step 2B). The calculation command can also be in the downloaded from a WAP/HTML/XML page.

The procedure for adding the identity to the data content may need to be carried out by a secure hardware means. For example, a specifically designed microprocessor that is very hard to hack and/or modify may be used. The SIM is one example of such secure hardware.

It is also noted herein that while the above describes exemplifying embodiments of the invention, there are several variations and modifications which may be made to the disclosed solution without departing from the scope of the present invention as defined in the appended claims.

1. A method of providing a data entity with a digital identification, wherein a terminal adapted for transportation of the data entity provides the content of the data entity with a digital identification based on a unique code associated with the terminal.

2. A method as claimed in claim 1, wherein the unique code comprises an equipment identity code associated with the terminal.

3. A method as claimed in claim 2, wherein the equipment identity code comprises the international mobile equipment identity (IMEI) of the terminal.

4. A method as claimed in claim 1, wherein the unique identifier is provided based on a digital certificate.

5. A method as claimed in claim 1, wherein the unique code comprises a subscriber identity code associated with the terminal.

6. A method as claimed in claim 4, wherein the subscriber identity code comprises the international mobile subscriber identity (IMSI) code.

7. A method as claimed in claim 1, wherein information associated with the unique code is stored in the terminal.

8. A method as claimed in claim 1, wherein information associated with the unique code is stored in a subscriber identity module (SIM) of the terminal.

9. A method as claimed in claim 1, wherein the digital identification is provided by digitally modifying the content.

10. A method as claimed in claim 9, wherein said digital modifying is based on a shared secret.

11. A method as claimed in claim 10, wherein the secret is shared between the creator of the content and a service provider providing services based on said digital identification.

12. A method as claimed in claim 10, wherein the secret is shared between the creator of the content and a terminal using the content.

13. A method as claimed in claim 9, wherein the modification is provided by watermarking the content.

14. A method as claimed in claim 13, wherein the watermarking is provided by modifying image pixel colour values of content comprising image data and/or by modifying audio sample bytes of content comprising audio data.

15. A method as claimed in claim 1, wherein the terminal automatically provides content with digital identification before transmission of the content.

16. A method as claimed in claim 1, comprising transportation of the data entity including the content via a communication system and detecting that the content is used or is going to be used by a user equipment.

17. A method as claimed in claim 16, wherein the detection is accomplished by a node in the communication system.

18. A method as claimed in claim 16, wherein the detection is accomplished at the user equipment.

19. A method as claimed in claim 1, wherein the terminal or the user of the terminal is identified based on the digital identification.

20. A method as claimed in claim 1, comprising identifying the author of the content based on the digital identification and rewarding said author based on the detected use of the content by another party.

21. A method as claimed in claim 20, wherein the content comprises material on which the user of the terminal has a copyright.

22. A method as claimed in claim 1, wherein the data entity is transported via a data communication network and wherein the digital identification provided in the content is removed before the content is transferred to a user equipment from the data communication network.

23. A method as claimed in claim 1, wherein the data entity is for transferring transaction data.

24. A method as claimed in claim 23, wherein the unique identification comprises a checksum and a certificate that associate with an electronic transaction application.

25. A user equipment adapted for transporting data, comprising data processing means for processing data to be transported such that the data is provided with a digital identification that is based on a unique code associated with the user equipment.

26. A user equipment as claimed in claim 25, wherein the unique code comprises an equipment identity code.

27. A user equipment as claimed in claim 25, wherein the unique identifier is provided based on a digital certificate.

28. A user equipment as claimed in claim 25, wherein the unique code comprises a subscriber identity code associated with the terminal.

29. A user equipment as claimed in claim 25, wherein the data processing means is adapted to provide the digital identification by modifying the data.

30. A user equipment as claimed in claim 25, comprising a mobile station providing a wireless communication interface for the user thereof.

31. Use of the user equipment as claimed in claim 25, comprising transmission of data together with a unique identification from the user equipment, and accomplishing a financial transaction between at least two parties.

32. A communication system comprising a node for monitoring communications in the system, said node being adapted to detect if data transmitted via the system is provided with a digital identification that is based on a unique code associated with a user equipment.

33. A communication system as claimed in claim 32, comprising means for detecting if the data is used or is going to be used by a user equipment.

34. A communication system as claimed in claim 32, comprising storage means for storing data associated with the user equipment and/or the user of the user equipment for use during the process of identifying the user equipment and/or the user based on the digital identification.

35. A communication system as claimed in claim 32, comprising means for identifying the author of a work transported in the communication system by means of said data based on the digital identification and means for rewarding said author if the work is consumed by another party than the author.
